(19) United States
(12) Patent Application Publication
(10) Pub. No.: US 2013/0001382 A1
(43) Pub. Date: Jan. 3, 2013

(54) PORTABLE ELECTRONIC DEVICE HOLDER

(76) Inventor: Yong Cheol Jang, Cheonan-si (KR)

(21) Appl. No.: 13/634,867

(22) PCT Filed: Feb. 18, 2011
(86) PCT No.: PCT/KR2011/001078

§ 371 Date: Sep. 13, 2012

(30) Foreign Application Priority Data
Mar. 15, 2010 (KR) 10-2010-0022834

(51) Int. Cl. F16M 11/00

(52) U.S. Cl. 248/176.1

(57) ABSTRACT

The present invention relates to a portable electronic device holder which enables a user to easily operate a portable electronic device such as a tablet PC, PDP, e-book reader, PMP, and netbook computer while comfortably holding and viewing the portable electronic device with one hand, and can also be used as a desktop holder such as a typical book rest. The portable electronic device holder according to one embodiment of the present invention comprises: a rectangular body member (10) disposed on the rear side of an electronic device; an upper end support member (20) coupled to the upper end of the body member and tightly contacting the top surface of the electronic device; a lower end support member (30) coupled to the lower end part of the body member (10) and tightly contacting the bottom surface of the electronic device; a handle member (40) coupled to the rear side of the body member (10); and a support member (50) coupled to both sides of the lower end part of the body is member (10) and configured to rotate downward at the rear of the body member.

### TECHNICAL FIELD

The present invention relates to a portable electronic device holder which enables a user to comfortably hold with one hand and easily watch a portable electronic device such as a tablet device, a PDP, an electronic book reader, a PMP, a network book computer, etc.

In addition, the present invention relates to a portable electronic device holder which enables a user to comfortably watch by obliquely fixing at a floor or a desk without a user holding with hands a portable electronic device.

### BACKGROUND ART

Generally, the supply of a portable electronic device such as a tablet device, a PDP, an electronic book reader, a PMP, a network book computer, etc. increases, and their kinds and sizes are being diversified.

However, when enjoying various contents such as watching a certain movie on a relatively larger portable electronic device or listening to music from it, it is inevitably needed to support the sides of a portable electronic device with both hands.

In particular, when a user uses a portable electronic device on a subway train, a bus or the like, since the user must keep a balance of his body while holding a grip with one hand, there is a handful of problems for holding a portable electronic device with the other hand.

The inventor researched and completed an invention which allows a user to stably hold a portable electronic device with one hand and to easily watch it.

### DISCLOSURE OF INVENTION

Accordingly, it is an object of the present invention to provide a portable electronic device holder which allows a user to hold comfortably with one hand a portable electronic device such as a tablet device, a PDP, an electronic book reader, a PMP, a network book computer and the like, with the other end handling the contents.

It is another object of the present invention to provide a portable electronic device holder which makes it possible for a user to comfortably watch a portable electronic device in such a way to obliquely fix it at a floor or the like without holding it with hands.

To achieve the above objects, according to an embodiment of the present invention, there is provided a portable electronic device which comprises a rectangular body member 10 which is positioned at a backside of an electronic device, an upper side support member 20 which is engaged to an upper side of the body member and comes into close contact with an upper surface of an electronic device, a lower side support member 30 which is engaged to a lower side of the body member 10 and comes into close contact with a lower surface of an electronic device, and a handle member 40 which is engaged to a backside of the body member 10, and the upper side support member 20 comprises an upper side extension part 21 one end of which is integrally engaged with the body member 10, and the other end of which is forwardly extended from an upper surface of the electronic device, and an upper side close contact part 23 which extends toward a front side of an upper side of the electronic device and is engaged to the upper side extension part, and the lower side support member 30 comprises a lower side extension part 31 one end of which is integrally engaged with the body member 10, and the other end of which is forwardly extended from a lower side surface of the is electronic device, and a lower side close contact part 33 which extends toward a front side of a lower side of the electronic device and is engaged to a lower side extension part, and the upper and lower side close contact parts 23 and 33 are the pads which have close contact natures and are made of a rubber material and come into close contact with the upper and lower surfaces of the electronic device and have through holes 24 and 34 at their centers, and at one side of its front surface are protruded fixing parts 25 and 35 in the direction of the front surface of the electronic device, and at an inner surface of the lower side extension part are formed fixing protrusions 22 and 32 which are fixedly inserted into the through holes 24 and 34 of the upper and lower side close contact part.

Preferably, the handle member 40 is formed of a front side plate 41 and a backside band 42, the center of the front side plate 41 being rotatably installed at the body member 10 by way of the rotation center pin 43.

Preferably, there is further provided a support member which is engaged to both sides of a lower side of the body member 10 and rotates from a backside of the body member to a lower side.

Preferably, the support member 50 is fixed with a rotation member so it can rotate a certain angle behind the body member, and the rotation member comprises a rotation protrusion 51 which is positioned at both sides of the body member and has a through hole at its center and a stopper which extends outwardly and is formed at an inner surface of a hollow hole, a rotation hole 53 which is positioned at an inner side of both sides of the support member and into which a rotation protrusion is inserted, an elastic spring 54 which is inserted into the rotation hole of the support member, and an engaging part 55 one end of which has an angle adjusting groove matching with the stopper, and the other end of which is inserted into the rotation hole and is engaged, so it comes into close contact with the elastic spring.

Preferably, the upper and lower side support members, and the upper and lower close contact parts have damage prevention holes which vertically pass through in the direction from front sides to inner sides.

The portable electronic device holder according to another embodiment of the present invention is characterized in that an upper side of the body member has an upper side opening in an inward direction, and the lower side of the upper side support member is inserted into the opening of the body member, and the lower side of the upper side support member is connected with the body part by way of a spring and is engaged in such a way to move in upward and downward directions, and the upper side of the lower support member is inserted into the lower side opening of the body member, and the upper side of the lower side support member is connected with the body member by way of a spring and is engaged to be movable in upward and downward directions.

In the portable electronic device holder according to another embodiment of the present invention, an upper side support member is characterized in that an end of the upper side extension part is open, and a protrusion is formed at a front side and is caught by an upper side surface of the electronic device, and there is provided an upper side fixing part a backside of which is inserted into the opening of the upper side extension part, and the lower side support member is characterized in that an end of the lower side extension part is open, and a protrusion caught by a lower side surface of the electronic device is formed at a front side, and there is provided a lower fixing part a backside of which is inserted into the opening of the lower side extension part.

### Advantageous Effects

The portable electronic device holder according to the present invention has advantages in that a user can comfortably hold and watch with one hand, not two hands, a portable electronic product such as a tablet device, a PDP, an electronic book reader, a PMP, a network book computer, etc., and the contents can be easily handled with the other hand.

In addition, the portable electronic device holder according to the present invention is advantageous to obliquely fix a portable electronic device at a floor of a desk at an angle allowing a user to comfortably watch without holding it with hands.

In addition, the portable electronic device holder according to the present invention is advantageous for a user to keep a comfortable posture even when using it for a long time in such way that part of a user's body can be stably supported in a state that a portable electronic device is fixed.

### BRIEF DESCRIPTION OF DRAWINGS

FIG. 1 is a disassembled perspective view illustrating a portable electronic device holder according to a first embodiment of the present invention.

FIG. 2 is a perspective view illustrating a portable electronic device holder of FIG. 1.

FIG. 3 is a cut-away view of FIG. 1.

FIG. 4 is a perspective view illustrating a portable electronic device holder according to a second embodiment of the present invention.

FIG. 5 is a cut-away view of a portable electronic device holder according to a second embodiment of the present invention.

FIG. 6 is a perspective view illustrating a portable electronic device holder according to a third embodiment of the present invention.

FIG. 7 is a cut-away view of a portable electronic device holder according to a third embodiment of the present invention.

FIG. 8 is a cut-away view of a portable electronic device holder according to a fourth embodiment of the present invention.

FIG. 9 is a cut-away view of a portable electronic device holder according to a fifth embodiment of the present invention.

FIG. 10 is a disassembled view illustrating a rotation member according to a fifth embodiment of the present invention.

FIG. 11 is a use state view of a portable electronic device holder according to the present invention.

### BEST MODES FOR CARRYING OUT THE INVENTION

The embodiments of the present invention will be described with reference to the accompanying drawings.

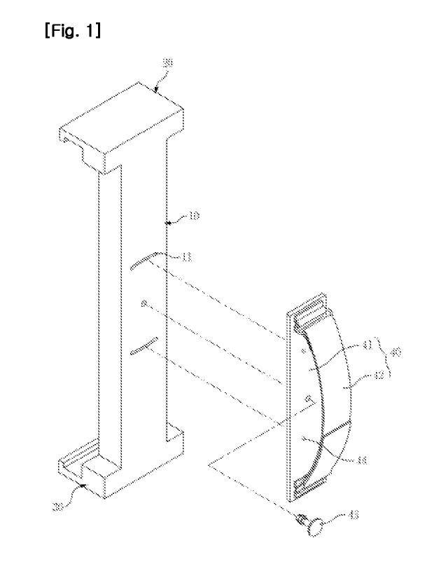

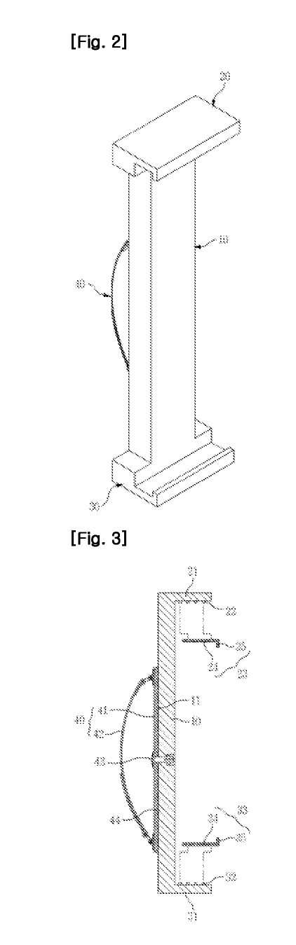

As shown in FIGS. 1 to 3, the portable electronic device holder according to a first embodiment of the present invention comprises a rectangular body member 10 which is positioned at a backside of an electronic device, an upper side support member 20 which is engaged to an upper side of the body member and comes into close contact with an upper side surface of the electronic device, a lower side support member 30 which is engaged to a lower side of the body member and comes into close contact with the lower side surface of the electronic device, and a handle member 40 which is engaged to a backside of the body member.

The upper side support member 20 comprises an upper side extension part 21 one end of which is engaged to the body member 10, and the other end of which is extended from an upper side surface of the electronic device to a forward direction, and an upper side close contact part 23 which extends toward a front side of the upper side of the electronic device and is engaged to the upper side extension part 21.

The lower side support member 30 comprises a lower side extension part 31 one end of which is engaged to the body member 10, and the other end of which is extended from a lower side surface of the electronic device to a forward direction, and a lower side close contact part 33 which extends toward a front surface of the lower side of the electronic device and is engaged to the lower side extension part.

The upper side close contact part 23 and the lower side close contact part 33 are pads which are made of rubber and have close contact natures and can come into close contact with the upper and lower side surfaces of the electronic device. The upper and lower side close contact parts 23 and 33 have through holes 24 and 34 at the center, and at the side of the front side are protruded fixing parts 25 and 35 toward the front surface of the electronic device, and at the inner side surfaces of the upper and lower side extension parts are formed fixing protrusions 22 and 32 which are fixedly inserted into the upper and lower side close contact parts 23 and 33.

The handle member 40 is formed of a front side plate 41 and a backside band 42, and the center of the front side plate 41 is installed to freely rotate at the body member 10 by way of a rotation center pin 43. In particular, an engaging protrusion 44 is formed at a front side upper portion or a front side lower portion of the front side plate 41. At a backside of the body 10 is formed a rotation groove 11, so the engaging protrusion 4 can be positioned in the rotation groove 11. When the front side plate 41 moves leftward and rightward, since the engaging protrusion 44 is rotatable in the rotation groove 11, the user come to freely adjust the rotation angle of the handle member 40 with respect to the body member 10.

In addition, the backside band 42 of the handle member is preferably installed in such a way of a Velcro junction method so that an insertion space formed between the front side plate 41 and the backside band 42 can be adjusted depending on the size of a user's hand.

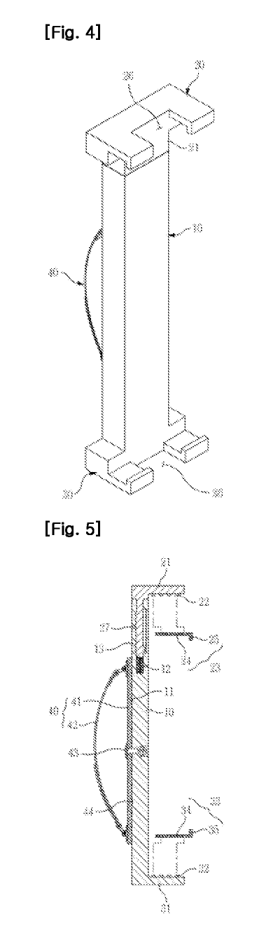

As shown in FIGS. 4 and 5, the portable electronic device holder according to a second embodiment of the present invention is characterized in that the upper side support member 20 is inserted into the upper side o the body member 10 and is engaged to be movable in the upward and downward directions, and the lower side support member 30 can be integrally engaged with the body member 10. In other words, the upper side of the body member 10 has an upper side opening in its inner side, and the lower side of the upper side support member 20 is inserted into the upper side opening of the body member 10. In addition, the lower side of the upper side support member 20 is engaged with the body member 10 by way of a spring 12, so the upper side support member 20 is attracted to come into close contact with the body member with the aid of the recovery force of the spring. At this time, the upper side extension part 21 and the upper side close contact part 23 have upper side damage prevention holes 26 which vertically pass through the upper sides to the lower sides for the purpose of preventing the injuries of users fingers when coming into close contact with the electronic device with the aid of the recovery force of the spring.

In the inner side of the opened body member 10 is formed an engaging groove 13, and at an outer surface of the upper side support member 20 inserted into the body member 10 is formed an engaging protrusion 27. As such it is possible to prevent a phenomenon that the upper side support member 20 is quickly attracted toward the body member 10 by means of the engaging groove 13 and the engaging protrusion 27 with the aid of the elastic force of the spring 12 and to prevent the upper side support member 20 from being widened by means of an external impact.

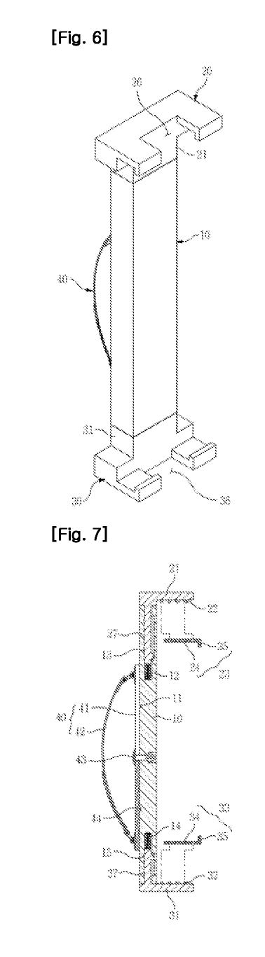

As shown in FIGS. 6 and 7, the portable electronic device holder according to a third embodiment of the present invention is characterized in that the upper side support member 20 and the lower side support member 30 are inserted into the upper side and the lower side of the body member 10, so they are engaged in such a way to be movable in upward and downward directions. In other words, the upper side and the lower side of the body member 10 have upper and lower side openings in their inner sides, and the lower side of the upper side support member 10 and the upper side of the lower side support member 30 are inserted into the upper and lower side openings of the body member 10, respectively, and the lower side of the upper side support member 20 and the upper side of the lower side support member 30 are engaged to the body member 10 by way of the springs 12 and 14. In addition, as shown in FIG. 4, at the upper and lower side extension parts 21 and 31 and the upper and lower close contact parts 22 and 33 are formed damage prevention holes 26 and 36 which pass through the upper side surface and the lower side surface for the purpose of preventing the injuries of a users finder when coming into close contact with the electronic device by means of the recovery force of the spring 12 and 14.

In addition, at the inner side of the opened body member 10 is formed engaging grooves 13 and 15, and at the outer side surfaces of the upper side support member 20 and the lower side support member 30 inserted into the body member 10 are formed engaging protrusions 27 and 37, respectively.

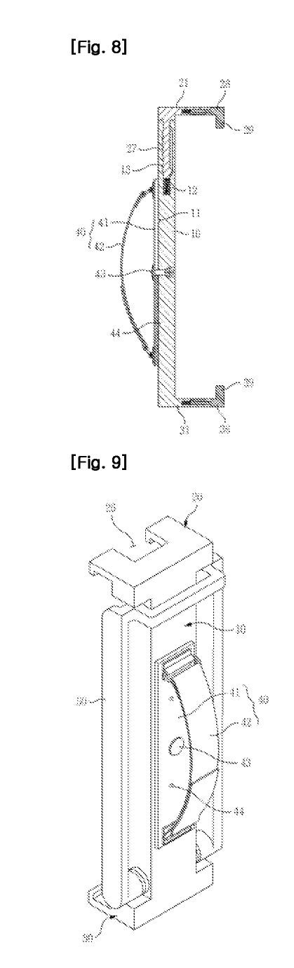

As shown in FIG. 8, the upper side support member 20 of the portable electronic device holder according to a fourth embodiment of the present invention has an upper side fixing part 28 which is characterized in that at an end of the upper side extension part 21 is formed a front side opening opened in the inward direction, and the backside of it is inserted into the front side opening of the upper side extension part 21, the upper side fixing part 28 having a protrusion 29 caught at the upper side surface of the electronic device at the front side. In addition, the lower side support member 30 is characterized in that at an end of the lower side extension part 31 is formed a front side opening which is opened toward the inward side, and the backside of it is inserted into the front side opening of the lower side extension part 31, the lower side fixing part 38 having a protrusion 39 which is caught by the lower side surface of the electronic device. At this time, in the interiors of the upper side extension part and the lower side extension part is formed an engaging groove, and at the outer surfaces of the upper side fixing part and the lower side fixing part are formed an engaging protrusion, respectively, and it is preferred that the backsides of the upper side fixing part 28 and the lower side fixing part 38 are engaged with the upper side extension part 21 and the lower side extension part 31, respectively.

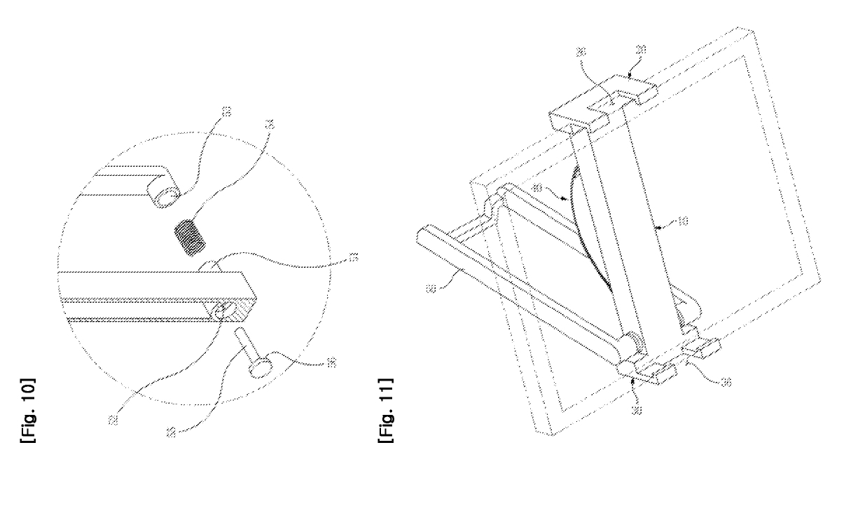

As shown in FIGS. 9 and 10, the portable electronic device holder according to a fifth embodiment of the present invention is characterized in that there is further provided a support member 50 which is engaged to both sides of a lower side of the body member 10 and which is rotatable from the backside of the body member 10 toward the lower side. The support member 50 is fixed to be rotatable at a certain angle at the backside of the body member 10 by way of a rotation member.

Preferably, the rotation member comprises a rotation protrusion 51 formed at the body member 10, a rotation hole 53 formed at the support member 50, an elastic spring 54 inserted into the rotation hole, and an engaging part 55 for engaging the rotation protrusion and the rotation hole. The rotation protrusion 51 is positioned at both sides of the body member 10 and is protruded in an outward direction and has a through hole at the center of it and is formed a stopper 52 at the inner side surface, and the rotation hole 53 is positioned at the inner side of both sides of the support member 50, and the rotation protrusion 51 is inserted into it. In addition, the engaging part 55 has one end in which an angle adjusting groove 56 matching with the stopper is formed, and the other end which is inserted into the rotation hole 53 and is engaged and comes into close contact with the elastic spring 54.

Even when the support member 50 is placed on the ground such as a desk in a state that it is rotated at about 60 degrees, 45 degrees and 30 degrees at the backside of the body member 10 with the aid of the rotation member, the body member 10 does not move, so the user can comfortably watch the screen of the electronic device since it is not needed to support it with a palm.

The use state of the portable electronic device holder according to the present invention will be described. First of all, in a state that the upper side close contact part 23 and the lower side close contact part 33 are adjusted to have certain lengths depending on the sizes of the upper side and the lower side of the electronic device, the fixing protrusions 22 and 32 of the upper and lower side extension parts 21 and 31 are inserted into the through holes 24 and 34 of the upper and lower side close contact parts 23 and 33.

Afterward, in a state that the body member 10 is placed on the backside of the electronic device, the upper side support member 20 and the lower side support member 30 are placed to come into close contact with the upper side and the lower side of the electronic device. At this time, the upper side support member 20 or the lower side support member 30 is adjusted by moving it in the upward or downward direction depending on the upper and lower length of the electronic device. The body member 10, the upper and lower side support members 20 and 30, and the upper and lower side close contact parts 23 and 33 are integrally engaged for thereby stably fixing the electronic device. In this state, when the body member 10 is supported on the palm by inserting one hand into the handle member 40, a user can comfortably watch the screen of the electronic device while holding it.

As described above, when watching the electronic device using the handle member in a state that the portable electronic device holder is engaged, it is possible to comfortably support the electronic device in such a way to rotate the handle member 40 in one directing depending on the configuration of a users body. In other words, when the electronic device is supported with a left hand, it is possible to comfortably support the electronic device in such a way to slightly rotate the handle member 40 in a counterclockwise direction in a state that the left hand is inserted into the handle member. When the electronic device is supported with the right hand, it is possible to comfortably support the electronic device in such a way to slightly rotate the handle member 40 in a clockwise direction in a state that the right hand is inserted in the handle member 40.

Even when watching the electronic device in a state that it is placed on the floor such as a desk, etc., it is placed on the floor in a state that the support member 50 is rotated at 60 degrees, 45 degrees, and 30 degrees with respect to the body member 10, so the electronic device can be stably supported with the aid of the support member, whereby as such the user can comfortably watch the electronic device without supporting it with a user's palm.

In addition, when the support member 50 is rotated by about 180 degrees at the backside of the body member 10, the end of the support member 50 is supported on a user's stomach portion or on a certain portion of the user's body when holding the electronic device with one hand, so it is possible to more stably support the electronic device because the weight of the electronic device can be dispersed.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A portable electronic device holder, comprising:
a rectangular body member which is positioned at a backside of an electronic device;
an upper side support member which is engaged to an upper side of the body member and comes into close contact with an upper side surface of the electronic device;
a lower side support member which is engaged to a lower side of the body member and comes into close contact with a lower side surface of the electronic device; and
a handle member which is engaged to a backside of the body member, and
said upper side support member comprising:
an upper side extension part one end of which is integrally engaged with the body member, and the other end of which is extended in a forward direction from an upper side surface of the electronic device; and
an upper side close contact part which extends toward a front surface of the upper side of the electronic device and is engaged with the upper side extension part, and
said lower side support member comprising:
a lower side extension part one end of which is integrally engaged with the body member, and the other end of which extends toward a front side from the lower side surface of the electronic device; and
a lower side close contact part which extends toward a front side of the lower side of the electronic device and is engaged with a lower side extension part, and
said upper and lower close contact parts and being pads which are made of rubber materials and have close contact natures and are come into close contact with the upper and lower side surfaces of the electronic device and have through holes at the centers of them, and fixing parts are protruded from one side of the front side toward the front side of the electronic device, and at the inner side surfaces of the upper and lower extension part are formed fixing protrusions which are fixedly inserted into the through holes of the upper and lower side close contact part.

2. A portable electronic device holder according to claim 1, wherein said handle member is formed of a front side plate and a backside band, the center of the front side plate being rotatably installed at the body member by way of the rotation center pin.

3. A portable electronic device holder, comprising:
a rectangular body member which is positioned at a backside of an electronic device;
an upper side support member which is engaged to an upper side of the body member and comes into close contact with an upper side surface of the electronic device;
a lower side support member which is engaged to a lower side of the body member and comes into close contact with a lower side surface of the electronic device; and
a handle member which is engaged to a backside of the body member, and
an upper side opening is inwardly formed at an upper side of the body member, and the lower side of the upper side support member is inserted into the opening of the body member, and the lower side of the upper side support member is connected with the body member by way of the spring and is movable in upward and downward directions.

4. A portable electronic device holder according to claim 5, wherein the lower side of the body member 10 has a lower side opening formed in an inward direction, and the upper side of the lower side support member 30 is inserted into the lower side opening of the body member, and the upper side of the lower side support member is connected with the body member by way of a spring and is movable in the upward and downward directions and is engaged.

5. A portable electronic device holder according to claim 2, wherein an engaging groove is formed at an inner side of the opened body member, and an engaging protrusion is formed at an outer side surface of the support member inserted in the body member.

6. A portable electronic device holder according to claim 2, wherein there is provided an injury prevention hole which passes through from the upper side to the lower side in the inward direction from the front sides of the upper and lower side support members and the upper and lower side close contact parts.

7. A portable electronic device holder, comprising:
a rectangular body member which is positioned at a backside of an electronic device;
an upper side support member which is engaged to an upper side of the body member and comes into close contact with an upper side surface of the electronic device;
a lower side support member which is engaged to a lower side of the body member 10 and comes into close contact with a lower side surface of the electronic device; and
a handle member which is engaged to a backside of the body member, and
said upper side support member comprising:
an upper side extension part one end of which is integrally connected with the body member, and the other end of which extends in a forward direction from the upper side surface of the electronic device and has an end opened; and
an upper side fixing part which has a protrusion formed at a front side and caught by an upper side surface of the electronic device and a backside inserted to the opening of the upper side extension part, and
said lower side support member comprising:
a lower side extension part one end of which is integrally engaged with the body member, and the other end of which extends in a forward direction from a lower side surface of the electronic device, the lower side extension part having an end opened; and
a lower side fixing part which has a protrusion formed at a front side and caught by a lower side surface of the electronic device and has a backside inserted into the opening of the lower side extension part.

8. A portable electronic device holder, comprising:
a rectangular body member which is positioned at a backside of an electronic device;
an upper side support member which is engaged to an upper side of the body member and comes into close contact with an upper side surface of the electronic device;
a lower side support member which is engaged to a lower side of the body member 10 and comes into close contact with a lower side surface of the electronic device;
a handle member which is engaged to a backside of the body member; and
a support member which is engaged to both sides of a lower side of the body member 10 and rotates from a backside of the body member to the lower side, and
said support member being fixed by a rotation member so that it can rotate at a certain angle from the backside of the body member.

9. A portable electronic device holder according to claim 8, wherein said rotation member comprises:
a rotation protrusion which is positioned at both sides of the body member and has a through hole at its center and a stopper which extends outwardly and is formed at an inner surface of a hollow hole;
a rotation hole which is positioned at an inner side of both sides of the support member and into which a rotation protrusion is inserted;
an elastic spring which is inserted into the rotation hole of the support member; and
an engaging part one end of which has an angle adjusting groove matching with the stopper, and the other end of which is inserted into the rotation hole and is engaged, so it comes into close contact with the elastic spring.

10. A portable electronic device holder according to claim 3, wherein an engaging groove is formed at an inner side of the opened body member, and an engaging protrusion is formed at an outer side surface of the support member inserted in the body member.

11. A portable electronic device holder according to claim 3, wherein there is provided an injury prevention hole which passes through from the upper side to the lower side in the inward direction from the front sides of the upper and lower side support members and the upper and lower side close contact parts.
